(19) United States
(12) Patent Application Publication
(10) Pub. No.: US 2008/0247936 A1
(43) Pub. Date: Oct. 9, 2008

(54) Method For Producing High Purity Silicon

(75) Inventors: Nobuaki Ito, Chiba (JP); Jiro Kondo, Chiba (JP); Kensuke Okazawa, Chiba (JP); Masaki Okajima, Chiba (JP)

Correspondence Address: BIRCH STEWART KOLASCH & BIRCH, PO BOX 747, FALLS CHURCH, VA, 22040-0747, US

(73) Assignee: NIPPON STEEL MATERIALS CO., LTD., TOKYO (JP)

(21) Appl. No.: 11/885,749

(22) PCT Filed: Feb. 28, 2006
(86) PCT No.: PCT/JP2006/304199

§ 371 Date: May 22, 2008

(30) Foreign Application Priority Data
Mar. 7, 2005 (JP) 2005-062556
Feb. 10, 2006 (JP) 2006-034342

(51) Int. Cl. C01B 33/02

(52) U.S. Cl. 423/349

(57) ABSTRACT

An object of the present invention is to provide a method for producing a great deal of inexpensive high purity silicon useful in a solar battery. Disclosed is a method for producing the high purity silicon by migrating impurities in molten silicon to slag including the step of feeding an oxidizing agent to the molten silicon together with slag, wherein the oxidizing agent is a material comprising as a primary component at least one of the following materials: alkali metal carbonate, hydrate of alkali metal carbonate, alkali metal hydroxide, alkaline-earth metal carbonate, hydrate of alkaline-earth metal carbonate or alkaline-earth metal hydroxide.

This application claims priority to Japanese patent application No. 2005-062556, filed in Japan on Mar. 7, 2005, and Japanese patent application No. 2006-034342, filed in Japan on Feb. 10, 2006, the entire contents of which are herein incorporated by reference.

### BACKGROUND OF THE INVENTION

1. Field of the Invention

The present invention relates to a method for producing high-purity silicon. The high-purity silicon is used for a solar battery.

2. Description of the Related Art

As for silicon to be used for a solar battery, the purity has to be 99.9999 mass % or more, each of the metallic impurities in the silicon is required to be not more than 0.1 mass ppm. Especially, the impurity of boron (B) is required to be not more than 0.3 mass ppm. Although silicon made by the Siemens Process, which is used for a semiconductor, can meet the above requirements, the silicon is not suitable for a solar battery. This is due to the fact that the manufacturing cost of silicon by the Siemens Process is high while a solar battery is required to be inexpensive. Several methods have been presented in order to produce high-purity silicon at a low cost.

The process of unidirectional solidification of silicon metal has been well known for a longtime. In such a process, molten silicon metal is unidirectionally solidified to form a more purified solid phase silicon utilizing the difference in solubility of impurities between solid phase and liquid phase. Such a process can be effectively used for purifying silicon from a variety of metallic impurities. However, this method cannot be used for purifying silicon from boron because the difference in solubility of boron between solid phase and liquid phase is too small to purify silicon from boron.

The process of vacuum melting silicon is also well known. This process removes low boiling point impurities from silicon by holding molten silicon in a vacuum state and is effective to remove carbon impurities from silicon. However, this method cannot be applied to purifying silicon from boron because boron in molten silicon does not normally form a low boiling point substance.

As mentioned above, boron has been thought to be a problematic component because boron in silicon is the most difficult impurity to removed from and yet greatly affects the electrical property of silicon. Methods for which the main purpose is to remove boron from silicon are disclosed as follows.

JP56-32319A discloses a method for cleaning silicon by acid, a vacuum melting process for silicon and a unidirectional solidification process for silicon. Additionally, this reference discloses a purification method using slag for removing boron, where the impurities migrate from the silicon to the slag, which is placed on the molten silicon. In the patent reference JP56-32319A, the partition ratio of boron (concentration of boron in slag/concentration of boron in silicon) is 1.357 and the obtained concentration of boron in the purified silicon is 8 mass ppm by using slag including (CaF₂+CaO+SiO₂). However, the concentration of boron in the purified silicon does not satisfy the requirement of silicon used for solar batteries. The disclosed slag purification cannot industrially improve the purification of silicon from boron because the commercially available raw material for the slag used in this method always contains boron on the order of several ppm by mass and the purified silicon inevitably contains the same level of boron concentration as in the slag unless the partition ration is sufficiently high. Consequently, the boron concentration in the purified silicon obtained by the slag purification method is at best about 1.0 mass ppm when the partition ratio of boron is 1.0 or so. Although it is theoretically possible to reduce the boron concentration by purifying the raw materials for the slag, this is not industrially feasible because it is economically unreasonable.

JP58-130114A discloses a slag purification method, where a mixture of ground crude silicon and slag containing alkaline-earth metal oxides and/or alkali metal oxides are melted together. However, the minimum boron concentration of the obtained silicon is 1 mass ppm, which is not suitable for a solar battery. In addition, it is inevitable that new impurities are added when the silicon is ground, which also makes this method inapplicable to solar batteries.

JP2003-12317A discloses another purification method. In this method, fluxes such as CaO, CaO₃ and Na₂O are added to silicon and they are mixed and melted. Then, blowing oxidizing gas into the molten silicon results in purification. However, silicon purified by this method has a boron concentration of about 7.6 mass ppm, which is not suitable for use in a solar battery. Furthermore, it is difficult, from an engineering point of view, to blow stably oxidizing gas into molten silicon at low cost. Therefore, the method disclosed in JP2003-12317A is not suitable for the purification of silicon.

Non-patent reference, “Shigen to Sozai” (Resource and Material) 2002, vol. 118, p. 497-505, discloses another example of slag purification where the slag includes (Na₂O+CaO+SiO₂) and the maximum partition ratio of boron is 3.5. The partition ratio 3.5 is the highest value disclosed in the past, however, this slag purification is still inapplicable to solar batteries considering the fact that the boron concentration in the practically available raw material of slag.

As mentioned above, conventional slag purification methods, which fail to obtain a practically available high partition ratio of boron, are not suitable for obtaining silicon useful in a solar battery. The reason why the partition ratio of boron, when purifying silicon from boron, tends to be low is that silicon is oxidized as easily as boron. In slag purification methods, boron in silicon tends to be non-oxidized and the non-oxidized boron is hardly absorbed in the slag. The slag purification method is widely used for removing boron from steel because boron is far more easily oxidized than steel. Because of the essential difference in properties between steel and silicon, the slag purification technique in steel industry cannot simply be applied to removing boron from silicon.

Boron removal techniques other than slag purification have also been proposed. Such techniques include various purification methods where boron in silicon is removed by vaporization after being oxidized.

JP04-130009A discloses a boron removal method where boron in silicon is removed by blowing plasma gas with gases such as water vapor, O₂ and/or CO₂ and oxygen-containing materials such as CaO and/or SiO₂ into the molten silicon.

JP04-228414A discloses a boron removal method where boron in silicon is removed by blowing a plasma jet with water vapor and SiO₂ into the molten silicon.

JP05-246706A discloses a boron removal method where boron in silicon is removed by blowing an inert gas or an oxidizing gas into the molten silicon while keeping an arc between the molten silicon and an electrode located above the surface of the molten silicon.

U.S. Pat. No. 5,972,107 and U.S. Pat. No. 6,368,403 disclose methods for purifying silicon from boron where a special torch is used and water vapor and SiO₂ are supplied in addition to oxygen and hydrogen and CaO, BaO and/or CaF₂ to molten silicon.

JP04-193706A discloses a boron removal method where boron in silicon is removed by blowing gas such as argon gas and/or H₂ gas into the molten silicon from a bottom inlet.

JP09-202611A discloses a boron removal method where boron in silicon is removed by blowing a gas including Ca(OH)₂, CaCO₃ and/or MgCO₃ into molten silicon.

Some techniques disclosed in the above mentioned references from JP04-130009A to JP09-202611A can remove boron from silicon to the extent that boron concentration in the silicon meets the requirements for use in a solar battery. All of these the techniques, however, use a plasma device and/or gas blowing apparatus which are expensive and require complicated operations. This makes it difficult to adopt these techniques as practical techniques from the viewpoint of economic efficiency. Also, since all of these techniques have a strong oxidizing ability, they may excessively oxidize the silicon along with oxidizing the boron, which significantly lowers the percentage yield of silicon. As mentioned before, boron and silicon can be oxidized to the same degree. Therefore, something special is required to selectively oxidize only boron with respect to the above techniques for removing boron from silicon by oxidizing the boron.

### SUMMARY OF THE INVENTION

An object of the present invention is to provide a method of producing high purity silicon simply at low cost by purifying crude silicon from impurities, particularly boron, to a level useful for solar batteries.

The present inventors have designed the following solutions after studying silicon production.

One embodiment of the present invention relates to a method for producing high purity silicon by migrating impurities in molten silicon to slag comprising: feeding an oxidizing agent to the molten silicon together with slag, wherein the oxidizing agent is a material comprising as a primary component at least one of the following materials: alkali metal carbonate, hydrate of alkali metal carbonate, alkali metal hydroxide, alkaline-earth metal carbonate, hydrate of alkaline-earth metal carbonate or alkaline-earth metal hydroxide.

In another embodiment, the oxidizing agent is fed to the molten silicon so as to directly contact the molten silicon.

In another embodiment, the alkali metal element or alkaline-earth metal include at least one of the following elements: lithium, sodium, potassium, magnesium, calcium and barium.

In yet another embodiment, the oxidizing agent is a material comprising as a primary component at least one of the following materials: sodium carbonate, potassium carbonate, sodium hydrogen carbonate, potassium hydrogen carbonate, magnesium carbonate, calcium carbonate, hydrates of each of the above carbonates, magnesium hydrate or calcium hydrate.

The method of the present invention is able to reduce the boron concentration of silicon to 0.3 mass ppm or less without using expensive equipment such as a plasma device or a gas-blowing device. The silicon obtained according to the present method is of a purity useful in solar batteries. Further, the combined use of the present invention and conventional unidirectional solidification processes or conventional vacuum melting processes can supply silicon available as a raw material for a solar battery with high quality and low cost.

The conventional technologies mentioned above can be classified into four categories. The first category includes methods where slag only is supplied onto molten silicon (disclosed in JP56-32319A and JP58-130114A, hereinafter referred to as “simple slag purification method”). The second category includes methods where an oxidizing gas is contacted with molten silicon (disclosed in JP04-228414A and JP05-246706A, hereinafter referred to as “gas oxidization method”). The third category includes methods where a solid oxidizing agent (e.g., MgCO₃) is blown into the molten silicon with a carrier gas (disclosed in JP09-202611, hereinafter referred to as “oxidizing agent blowing method”). The fourth category includes methods where in addition to contacting oxidizing gas with the molten silicon, slag and/or raw slag materials such as SiO₂ is also supplied to the molten silicon (disclosed in JP2003-12317A, JP04-130009A, U.S. Pat. No. 5,972,107, U.S. Pat. No. 6,368,403 and JP04-193706A, hereinafter referred to as “complex slag purification method”). Compared to the above, according to the present invention, slag is fed directly to the molten silicon together with an oxidizing agent. The present method does not belong to any of the above categories of conventional technology.

### BRIEF DESCRIPTION OF THE DRAWINGS

FIG. 1 is a schematic diagram showing an apparatus used for the present method.

FIG. 2a is an explanatory diagram illustrating boron behavior in the case of feeding pre-prepared slag to molten silicon.

FIG. 2b is an explanatory diagram illustrating boron behavior in the case of separately feeding each raw slag material onto the molten silicon to form a slag on the molten silicon.

FIG. 3a is an explanatory diagram providing one illustration of a mixture of slag and oxidizing agent over molten silicon.

FIG. 3b is an explanatory diagram providing another illustration of a mixture of slag and oxidizing agent over molten silicon.

FIG. 3c is an explanatory diagram providing an illustration of oxidizing agent placed on slag over molten silicon.

### PREFERRED EMBODIMENTS OF THE INVENTION

Advantages of the present invention are described below.

First, the conventional method of simple slag purification and the present method are compared. The simple slag purification method is based on the principle that boron migrates from silicon to slag based on the fact boron is thermodynamically more stable in slag than in silicon. Particularly, boron is more thermodynamically stable in slag with a high degree of basicity. However, it is believed that boron in silicon usually exists in the form of elemental boron, that is, as atomic boron, and the thermodynamic stability of elemental boron has no significant difference when in silicon compared to slag. This is the reason why the partition rate of boron in a simple slag purification method is low. Meanwhile, in the case where boron exists in silicon in the form of an oxide (boron oxide), the thermodynamic stability of the boron oxide is much higher in slag than in molten silicon. Consequently, the partition rate of boron can be greatly increased. In the present invention, since an oxidizing agent is added together with the slag, the boron in the molten silicon can be easily oxidized and thus, will migrate to the slag. In at least this respect, the present invention is superior to simple slag purification methods.

Second, conventional gas oxidization methods and oxidizing agent blowing methods are compared to the present method. Gas oxidization methods and oxidizing agent-blowing methods are based upon the principle that boron is removed from silicon by vaporization after converting boron into boron oxide with a low boiling point. This occurs by oxidizing the boron in the silicon by blowing an oxidizing gas or an oxidizing agent into the molten silicon. However, even if the boron is oxidized, since such a low boiling point material is not formed so quickly, the rate of boron removal tends to be lower than the rate of silicon oxidization by the oxidizing gas (or the oxidizing agent). Therefore, the percentage yield of silicon is significantly lowered because of loss of silicon due to oxidization. The specific mechanism of lowering the yield is as follows: The boron in the silicon is converted first into boron monoxide (BO) after contacting the oxidizing gas or the oxidizing agent. However, boron monoxide cannot be easily vaporized because of its low activity in silicon. To be vaporized, boron monoxide has to be converted into the higher molecular weight boron oxide, for example, B₂O₃. For that to occur, BO has to be further oxidized from some oxygen source and has to remain in the silicon for a time. As mentioned before, however, since boron and silicon can be oxidized to the same degree, BO remaining in the silicon for a long time has a high probability of contacting silicon atoms with high reactivity. As a result, the majority of BO is reduced back to elemental boron. As a whole, the oxidizing gas or the oxidizing agent is mainly consumed to oxidize silicon, which leads to a low percentage yield. Meanwhile, since BO formed in the silicon by the oxidizing agent in the present invention is much more stable in slag as mentioned before, the BO is absorbed one after another into the slag. Therefore, lowering of the percentage yield resulting from loss of silicon by oxidization is restrained according to the present invention. In at least this respect, the present method is superior to gas oxidization methods and oxidizing agent blowing methods.

Third, the conventional method of complex slag purification is compared with the present method. Complex slag purification is similar to the present invention in that both methods utilize an oxidizing agent and slag. However, there are differences between the complex slag purification method and the present method as follows: In complex slag purification, an oxidizing agent is not added to the slag and boron is oxidized mainly by being contacted with an oxidizing gas. Meanwhile, in the method of the present invention, an oxidizing agent is fed to the molten silicon together with the slag. The problems with oxidizing boron using an oxidizing gas are the same as set forth in the above comparison. In complex slag purification, the loss of silicon due to oxidization can be slightly mitigated since the slag functions as an absorbent of boron oxide. However, the location where the oxidization occurs (interface between the oxidizing gas and the molten silicon surface) and the location where the boron oxide is absorbed (interface between the slag and the molten silicon surface) are fundamentally separate from each other. Therefore, boron oxide may be reduced by silicon while moving in the molten silicon, which makes it difficult to maintain a high concentration of boron oxide at the interface between the slag and the molten silicon. Consequently, as the percentage of boron in a non-oxidized form increases in the slag, it cannot be expected to have much improvement in the partition rate of boron. As described previously, if the slag has a low partition rate of boron in purification where the boron concentration in the silicon is 1 mass ppm or less, this influences the removal of boron. The influence is due to the fact that when the boron concentration in the silicon is lowered by gas oxidization, the boron once stored in the slag through raw slag materials and through slag purification at high boron concentration, is dissolved out from the slag into the silicon. In the present method, since the oxidizing agent and the slag are adjacent to each other, oxidized boron is absorbed in the slag before being reduced by the silicon. Therefore, most of the boron in the slag is an oxidized form of boron, which can drastically increase the partition rate of boron. As a result, the problems of silicon loss due to oxidization and/or boron dissolving out of the slag, caused in complex slag purification can be greatly improved. In at least this respect, the present method is superior to the complex slag purification.

U.S. Pat. No. 5,972,107 suggests the possibility that SiO₂, fed as a raw slag material, functions by itself as an oxidizing agent. This possibility is based on the grounds that slag remaining after the purification process contains some oxidized impurities such as B₂O₃. The present inventors, however, have verified that such function as an oxidizing agent is negligibly small with respect to boron of which concentration in silicon is 1 mass ppm or less at 2000° C. or less under atmospheric pressure. In fact, the majority of past examples of slag purification use slag based on SiO₂ and the partition rates of boron are normally about 1, from which it is unreasonable to think that SiO₂ actively oxidizes boron. In view of this, the B₂O₃ in slag in the reference seems to be caused by the oxidizing gas and SiO₂ cannot be regarded as an oxidizing agent for boron. Also, the reference describes that CaO is fed to the molten silicon together with SiO₂ for slag formation. However, since CaO quoted as a representative material is generally a much more stable oxide than boron oxide, it is clear that additives such as CaO or the like described in the reference do not refer to oxidizing agents.

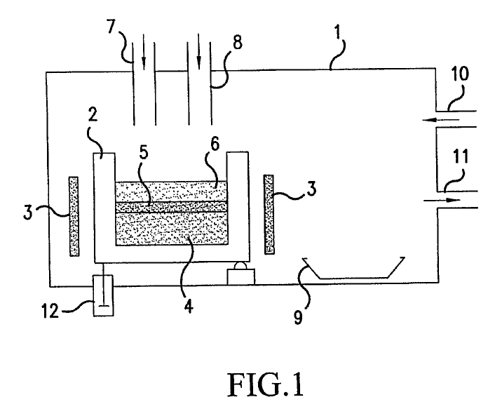

Construction of Apparatus: The construction of an apparatus according to the present invention is described below based on FIG. 1. A crucible 2, placed in a purification furnace 1, is heated by a heater 3. Molten silicon 4 is accommodated in the crucible 2 and kept at a certain temperature. An oxidizing agent 5 is fed through an oxidizing agent feeding tube 7 and slag 6 is fed through a slag feeding tube 8 onto the molten silicon 4 in the crucible 2. A reaction and purification including boron removal is commenced between the molten silicon, the oxidizing agent and the slag. During the heating and purification, the atmosphere inside the furnace is controlled with respect to the kinds of gas and gas concentration through a gas feeding line 10 and a gas exhaust line 11. When the oxidizing agent is consumed (by reaction with the molten silicon and the slag or by vaporization) and boron migration to the slag is almost complete, the slag and the oxidizing agent remaining on the molten silicon are discharged from the crucible by tilting the crucible using a crucible tilting devise 12 into a waste slag receiver 9. Then the crucible is set to the original position and, if necessary, slag and oxidizing agent are again fed onto the molten silicon 4 and the purification process is repeated.

Oxidizing agents: As for oxidizing agents, any oxidizing agents can be used as long as they meet the conditions of oxidizing ability, purity, ease of handling and price. Preferably, however, the oxidizing agent is a material comprising as a primary component at least one of the following materials: alkali metal carbonate, hydrate of alkali metal carbonate, alkali metal hydroxide, alkaline-earth metal carbonate, hydrate of alkaline-earth metal carbonate or alkaline-earth metal hydroxide. There are several reasons why these materials are preferred. First, they have a large oxidizing ability. Second, they contribute very little to contamination of the silicon by dissolving in the silicon. Third, they possess the property of stable slag formation with low melting point and low viscosity by reacting with the slag, which can make it easy to handle them with respect to exhaust and waste treatment. More preferably, the oxidizing agent should include at least one of the following materials: lithium, sodium, potassium, magnesium, calcium or barium as an alkali metal element or alkaline-earth metal element. Compounds of these elements have a higher ability to oxidize boron per unit mass than that of compounds of higher molecular weight. These compounds are also easily obtained, reasonable in price and safe and secure in using. Further preferably, the oxidizing agent is a material comprising as a primary component at least one of the following materials: sodium carbonate, potassium carbonate, sodium hydrogen carbonate, potassium hydrogen carbonate, magnesium carbonate, calcium carbonate, hydrates of each of the above carbonates, magnesium hydrate or calcium hydrate. There are several reasons why these materials are more preferred. First, these materials have the ability to form a SiO₂ film on the surface of the molten silicon, which inhibits contact between the molten silicon and the slag, and these materials form slag and are removed with the slag. Second, these materials are mass-produced goods and high purity products are surely obtained. Third, particularly with respect to the use of sodium carbonate or sodium hydroxide, boron in the slag can be changed to a “low boiling point material.” This low boiling point material includes compounds comprising boron and oxygen and/or boron, oxygen and sodium and is characterized by being easily vaporized and removed from the slag. The present inventors are the first to discover the phenomenon of formation of a “low boiling point material” and the removal by vaporization from the slag. The alkaline-earth metals mentioned include beryllium and magnesium.

Slag: As for slag, SiO₂ such as high purity silica sand with a low possibility of contaminating silicon or Al₂O₃ such as high purity alumina are preferred base materials. As described later, since it is preferable to operate the purification at a temperature close to the melting point of silicon, it is also desirable to lower the melting point and the viscosity of the slag by adding additives to the raw slag materials. As an example of such an additive, an oxidizing agent such as sodium carbonate, capable of removing boron by vaporization by changing boron to a low boiling point material, may be providing with the slag with high functionality. Or, it is also possible to add additives other than oxidizing agents, such additives being CaO, which make the reaction rate of the purification process milder. Regardless, it is unavoidable that a part of the oxidizing agent will react with the slag and some components of the oxidizing agent will migrate into the slag. As for the slag, commercially available high purity soda glass can be used after being crushed and heated. As for the temperature of the slag, it is preferably be 2000° C. or less in view of the desire to prevent silicon contamination and/or an excessive reaction rate.

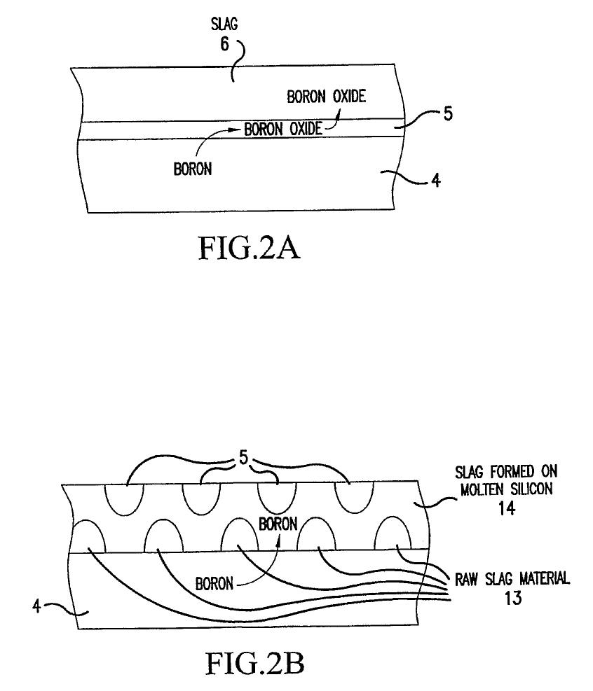

Slag, oxidizing agent feeding operation: The slag may be fed to the molten silicon after the slag raw materials are mixed and heated to form molten slag or glass state slag in advance. In the case of using an oxidizing agent as an additive to the slag, it is preferable to avoid feeding each of the raw slag materials separately onto the molten silicon and then forming the slag on the molten silicon. The reason is as follows: In the case of feeding slag prepared in advance to the molten silicon as shown in FIG. 2a, the amount of oxidizing agent as an additive can be the minimum required amount. During the purification process, the majority of oxidizing agent fed separately from the slag can be utilized for oxidizing boron in the molten silicon by contacting the silicon. This is due to the fact that, since reaction between the slag and the oxidizing agent is rather slow. On the other hand, in the case of feeding each of the raw slag materials separately onto the molten silicon and then forming the slag on the molten silicon as shown in FIG. 2b, the oxidizing agent is utilized for both the oxidizing reaction with boron and the slag formation reaction. Particularly at an early stage after feeding the oxidizing agent, most of the oxidizing agent is consumed for the slag formation reaction. This may have the cause that the boron in the silicon migrates to the slag before being oxidized. As a result, the ratio of boron oxide (vaporizable) in the slag becomes low, which leads to a low partition ratio of boron. In the case where an oxidizing agent is not added to the slag as an additives, (for example, CaO is added as an additive), there are no problems associated with feeding each of the raw slag materials separately onto the molten silicon to forming the slag on the molten silicon, and then feeding an oxidizing agent separately.

As for the oxidizing agent, soda ash or the like, a commercially available granular material, can be used without problems. As for the grain size, it preferably ranges from 1 mm to 50 mm in view of reactivity and feeding operationability. If a strong reaction can be allowed, it is possible to increase the reaction rate by feeding molten oxidizing agent directly on the molten silicon after heating the oxidizing agent in advance to a temperature slightly higher than the melting point. It should be noted, however, that the oxidizing agent are preferably be fed at a temperature under its decomposing temperature since a majority of alkali carbonates are decomposed/vaporized at a temperature of more than 1000° C.

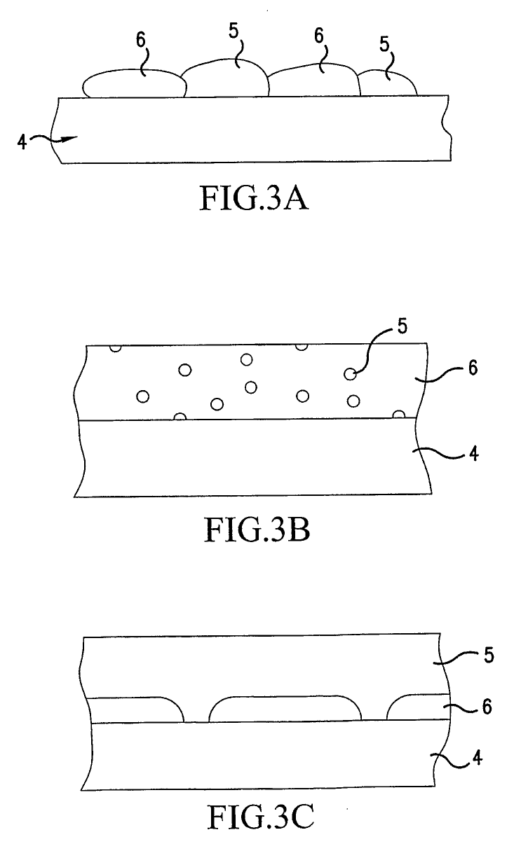

As for the positional relation between the fed slag and the fed oxidizing agent on the molten silicon, it is preferable to place the oxidizing agent directly on the molten silicon. Since the boron in the molten silicon can be mainly oxidized by direct contact with the oxidizing agent, the contact area between the molten silicon and the oxidizing agent is preferably as large as possible. Enlarging the contact area by stirring the molten silicon can increase the boron oxidization rate. It has been found by the present inventors that boron in the molten silicon is mainly oxidized by direct contact with the oxidizing agent and then immediately absorbed in the slag as boron oxide. This provides a high partition rate of boron. If lowering of the reaction rate is needed because the reaction rate is too fast for the operation, it is not necessary to place the oxidizing agent under the slag. Rather, the oxidizing agent may be fed so as to be mixed with the slag (as shown in FIG. 3a and FIG. 3b) or placed on the slag (as shown in FIG. 3c).

It is difficult to feed both slag and oxidizing agent exactly at the same time without preparing the mixture in advance. The slag and oxidizing agent being fed together means in practice that the slag and oxidizing agent fed within a short time interval of each other. Feeding in a short interval time means, for example, the slag is fed before a majority of the oxidizing agent is consumed (because of reaction with the molten silicon and/or decomposition/vaporization under high temperature). More specifically, for example, there is no problem if the feeding of the slag starts within 20 minutes after the oxidizing agent of tens of kg is initially fed.

Other operation conditions: As for the crucible to be used, stability against molten silicon and oxidizing agents is desired. For example, graphite and/or alumina can be used. A crucible of which the primary material is SiO₂ can be used in order to take advantage of elution of crucible material as a part of raw material for the slag.

As for the operation temperature, a high temperature operation is preferably avoided as much as possible in view of durability and contamination of the refractory lining. The temperature of the molten silicon is preferably between the melting point of silicon and 2000° C. The temperature of the silicon obviously has to be at the temperature of the melting point of silicon or higher.

As for the atmosphere of operation, a reducing atmosphere such as hydrogen gas is preferably avoided so as not to inhibit the oxidization of boron in the molten silicon. In the case where graphite is used as the crucible and/or the refractory lining, an oxidizing atmosphere such as air is preferably avoided in order to avoid the deterioration of the crucible and/or the refractory lining by oxidization. Therefore, an inert gas atmosphere such as an argon gas atmosphere is preferred. As for the ambient pressure, atmospheric pressure is desirable in terms of inexpensive facilities. However, unless there is a low pressure such as 100 Pa or less, there are no special limitations. At such a low pressure, the reaction between the molten silicon and the SiO₂ in the slag generates a great amount of SiO gas, which leads to very low percentage yield of silicon.

### EXAMPLES

### Example 1

Silicon purification is carried out using a purification furnace as shown in FIG. 1. 50 kg of metal silicon grains having a boron concentration of 12 mass ppm and average diameter of 5 mm is accommodated in the graphite crucible having a diameter of 500 mm placed in the purification furnace. The crucible is heated to 1500° C. in an argon atmosphere and molten silicon is maintained. In a second heating furnace, a mixture of 20 kg of high purity silica sand, of which the boron concentration is 1.5 mass ppm and of which the average diameter is 10 mm, and 5 kg of powdered sodium carbonate (Na₂CO₃), of which the boron concentration is 0.3 mass ppm, is accommodated in a graphite crucible and heated to and maintained at 1600° C. to form a slag. Then, 15 kg of powdered sodium carbonate (Na₂CO₃) of which boron concentration is 0.3 mass ppm is fed onto the molten silicon in the purification furnace through an oxidizing agent feeding tube, and the slag prepared in the second heating furnace is transported together with the crucible to the purification furnace and the crucible is tilted to feed the slag onto the molten silicon through a slag feeding tube. The time from feeding the oxidizing agent to feeding the slag is about 5 minutes. After finishing the feeding of the slag, temperature of molten silicon is maintained at 1500° C. and purification is carried out for 30 minutes. After finishing the purification, the crucible is tilted to discharge the slag and remaining oxidizing agent into a waste slag receiver and the molten silicon is sampled. The sampling is made as follows. One end of a high purity alumina tube, which is heated to a temperature greater than the melting point of silicon, is dipped into the molten silicon, and the molten silicon is sucked through the tube. Solidified silicon formed by quenching at a non-heated portion of the tube is carried out of the furnace and the solidified silicon is separated from the alumina tube as a sample to be analyzed. The weight of the sample is about 100 g. The method of component analysis of the sample is Inductively Coupled Plasma (ICP) analysis, a method which is widely used in the industry. Then, oxidizing agent and slag are fed again onto the molten silicon to repeat the purification. A total of purifications are carried out in this manner. The boron concentration of the finally obtained sample is 0.09 mass ppm, which satisfies the boron concentration requirements of silicon intended for solar batteries. The averaged partition rate of boron resulting from the silicon samples and the slag samples, which are sampled at each purification operation, is about 7.

### Example 2

In this example, sodium hydroxide is used as an oxidizing agent. All other materials and methods are the same as in Example 1. The boron concentration of the finally obtained sample is 0.08 mass ppm, which satisfies the boron concentration requirements of silicon intended for solar batteries.

### Example 3

In this example, MgCO₃ is used as an oxidizing agent. All other materials and methods are the same as in Example 1. The boron concentration of the finally obtained sample is 0.2 mass ppm, which satisfies the boron concentration requirements of silicon intended for solar batteries.

### ADDITIONAL NUMERIC SYMBOLS LIST

1: purification furnace
2: crucible
3: heater
4: molten silicon
5: oxidizing agent
6: slag
7: oxidizing agent feeding tube
8: slag feeding tube
9: waste slag receiver
10: gas feeding line
11: gas exhaust line
12: crucible tilting device
13: raw slag material
14: slag formed on molten silicon

All cited patents, publications, copending applications, and provisional applications referred to in this application are herein incorporated by reference.

The invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for producing high purity silicon by migrating impurities in molten silicon to slag comprising:
feeding an oxidizing agent to the molten silicon together with slag, wherein the oxidizing agent is a material comprising as a primary component at least one material selected from the group consisting alkali metal carbonate, hydrate of alkali metal carbonate, alkali metal hydroxide, alkaline-earth metal carbonate, hydrate of alkaline-earth metal carbonate and alkaline-earth metal hydroxide.

2. The method according to claim 1, wherein the oxidizing agent is fed to the molten silicon so as to directly contact the molten silicon.

3. The method according to claim 1, wherein the alkali metal element or alkaline-earth metal includes at least element selected from the group consisting of lithium, sodium, potassium, magnesium, calcium and barium.

4. The method according to claim 2, wherein the alkali metal element or alkaline-earth metal includes at least element selected from the group consisting of lithium, sodium, potassium, magnesium, calcium and barium.

5. A method for producing high purity silicon by migrating impurities in molten silicon to slag comprising:
feeding an oxidizing agent to the molten silicon together with slag, wherein the oxidizing agent is a material comprising as a primary component at least one material selected from the group consisting sodium carbonate, potassium carbonate, sodium hydrogen carbonate, potassium hydrogen carbonate, magnesium carbonate, calcium carbonate, hydrates of each of the above carbonates, magnesium hydrate and calcium hydrate.

6. The method according to claim 5, wherein the oxidizing agent is fed to the molten silicon so as to directly contact the molten silicon.

7. The method according to claim 1, wherein said oxidizing agent is fed onto said molten silicon and said slag is thereafter fed onto said oxidizing agent.

8. The method according to claim 5, wherein said oxidizing agent is fed onto said molten silicon and said slag is thereafter fed onto said oxidizing agent.
